(19) United States
(12) Patent Application Publication
(10) Pub. No.: US 2015/0134559 A1
(43) Pub. Date: May 14, 2015

(54) METHOD AND SYSTEM FOR TRACKING VESSELS

(71) Applicant: TRADENET COMMERCIAL NETWORKING LTD., Middlesex (GB)

(72) Inventor: Duncan MURRAY, Middlesex (GB)

(21) Appl. No.: 14/539,387

(22) Filed: Nov. 12, 2014

(30) Foreign Application Priority Data
Nov. 11, 2013 (GB) 1319821.3

(51) Int. Cl. G06Q 10/08

(52) U.S. Cl. CPC G06Q 10/0833
USPC 705/333

(57) ABSTRACT

The present invention relates to a method of tracking a vessel at a processing system, including: receiving location coordinates for the vessel associated with a vessel identifier; obtaining vessel data associated with the vessel identifier; processing the vessel data; and determining whether the vessel is berthed at one of a plurality of berth locations using the processed vessel data and the location coordinates. A system for tracking a vessel is also disclosed.

### FIELD OF INVENTION

The present invention is in the field of vessel tracking. Particularly, but not exclusively, the present invention relates to the detection of mooring status of vessels at berths.

### BACKGROUND

Cargo vessels travel between shipping ports carrying cargo from one port to off-load at another.

These vessels may retain their own records about where they berthed at each shipping port. However, there presently no mechanism to determine for any vessel which berth that vessel docked at each shipping port.

Existing mechanisms for tracking vessels can identify whether a vessel is within a port or other areas defined by zones, but is unable to determine at which berth the vessel docked at.

Another way to track vessels include aggregating reports of vessel sightings from port agents or broker reports to identify vessels within a port. This method comes with numerous disadvantages including unreliable or incomplete information.

There is a desire for a system which enables detects the docking of a vessel at a particular berth.

It is an object of the present invention to provide a vessel tracking method and system which overcomes the disadvantages of the prior art, or at least provides a useful alternative.

### SUMMARY OF INVENTION

According to a first aspect of the invention there is provided a method of tracking a vessel at a processing system, including:

receiving location coordinates for the vessel associated with a vessel identifier;
obtaining vessel data associated with the vessel identifier;
processing the vessel data; and
determining whether the vessel is berthed at one of a plurality of berth locations using the processed vessel data and the location coordinates.

The vessel data may include the length of the vessel. The step of processing the vessel data may include specifying a predefined length for the length of the vessel when the length of the vessel is outside a predefined range. The step of processing the vessel data may include increasing the vessel length by a predefined length when the vessel is not a tanker.

The location coordinates may be received from the vessel.

The vessel identifier may be received from the vessel.

The location coordinates may be received via a vessel location aggregator.

The method may further include the step of receiving vessel information from the vessel. The vessel information may include vessel velocity.

The step of determining whether the vessel is berthed may include the use of vessel velocity. The vessel may be determined to be berthed, at least, if the velocity of the vessel is below a threshold.

The vessel may be determined to be berthed at a berth location, at least, if the berth location is within a circle centred at the location coordinates with a radius of the processed vessel length.

The vessel may be determined to be berthed at a berth location, at least, if the berth location is the closest berth location to the location coordinates. The plurality of berth locations may include berth information.

The berth information may include whether the berth is fixed or floating.

The berth information may include whether the berth is fixed or floating and wherein, if the berth is floating, the processed vessel length is increased by a predefined length.

According to a further aspect of the invention there is provided a system for tracking vessels, including:

a processing system configured for receiving location coordinates for the vessel associated with a vessel identifier; obtaining vessel data associated with the vessel identifier; processing the vessel data; and determining whether the vessel is berthed at one of a plurality of berth locations using the processed vessel data and the location coordinates; and a berth database configured for storing berth locations.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2: shows a flow-chart illustrating a method in accordance with an embodiment of the invention;

FIG. 3: shows a map illustrating identified berth locations in accordance with an embodiment of the invention;

FIG. 4: shows a vessel at a berth illustrating the location of a GPS device;

FIG. 5: shows a flow-chart illustrating a berth tracking method in accordance with an embodiment of the invention; and

FIG. 6: shows a vessel at a berth illustrating a berth tracking method system in accordance with an embodiment of the invention.

### DETAILED DESCRIPTION OF PREFERRED EMBODIMENTS

The present invention provides a method and system for tracking vessels by determining whether the vessels are moored at a berth.

This invention may determine exactly which berth within a port a vessel is (or has been) moored at by using several of the following factors: the vessel's location coordinates, coordinates for berth locations, vessel length (to determine the distance from the berth), the vessel's current speed (only stationary or vessels moving at a very low speed may be considered), the berth type (berths at sea do not have fixed locations) and the vessel type (tankers moor near to connectors to off load liquid cargos whereas bulk vessels are not so precise in their mooring locations). Consideration of, at least, some of these factors may be used to create more accurate berth callings history for a vessel.

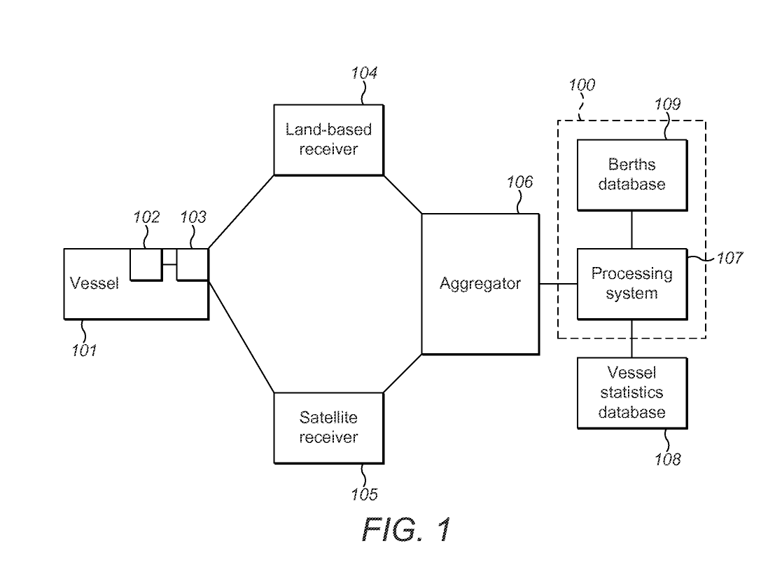

In FIG. 1, a system 100 in accordance with an embodiment of the invention is shown.

A vessel 101 is shown. The vessel 101 may include a location detection device 102, such as a GPS device, to determine current location coordinates for the vessel 101.

The vessel 101 may include a transmitter 103 to transmit messages for receipt by a receiver 104 or 105. The messages may include the location coordinates for a vessel 101 and an identifier for the vessel 101. The messages may be time-stamped.

A land-based receiver 104 and a satellite receiver 105 are shown. Either receiver 104 or 105 may receive the messages and relay them to an aggregator system 106.

The aggregator system 106 may compile messages from a plurality of vessels to provide a database of time-stamped location coordinates for the vessels. The aggregator may provide an interface to receive requests for data within the database and transmit that data to the requesting systems.

A processing system 107 is shown. The processing system 107 may request vessel coordinates using a vessel identifier. The vessel identifier may uniquely identify a vessel. The processing system 107 may obtain vessel data associated with the vessel identifier. The vessel data may be obtained from a vessel statistics database 108. The vessel statistics database 108 may be local to the processing system 107 or remote. The vessel data may include the length of the vessel associated with the vessel identifier. The vessel data may include information about the type of vessel, for example, whether the vessel is a bulk carrier or a tanker.

The processing system 107 may be configured to process the vessel data and utilise the processed vessel data in conjunction with the received vessel coordinates to determine whether the vessel is berthed at one of a plurality of berth locations. The berth locations may be stored in a berth database 109. The berth locations may be associated with other berth information, such as whether the berth is fixed or floating.

The processing system 107 may be configured to determine whether the vessel is berthed by determining whether a berth location falls within a circle centred at the location coordinates of a radius of the processed vessel length. If multiple berth locations fall within the circle, the closest berth location is selected. Further vessel information may be received such as velocity of the vessel. The velocity of the vessel may also be used to determine whether the vessel is berthed if the velocity of the vessel is below a predefined threshold. The vessel information may be received from the vessel via the aggregator system 106.

The length of the vessel may be processed in relation to the berth, for example, whether the berth is fixed or floating—where the berth is floating, a predefined length may be added to the vessel length. The length of the vessel may be processed in relation to the vessel data, for example, whether the vessel is a bulk carrier or a tanker—where the vessel is a bulk carrier, a predefined length may be added to the vessel length. The length of the vessel may be processed in relation to the length of the vessel obtained, for example, if the length of the vessel is outside a range, such as 0 m to 500 m, then a predefined length for the vessel may be assigned.

In an alternative embodiment, the location of the vessel may be determined externally to the vessel, for example, by a triangulation mechanism.

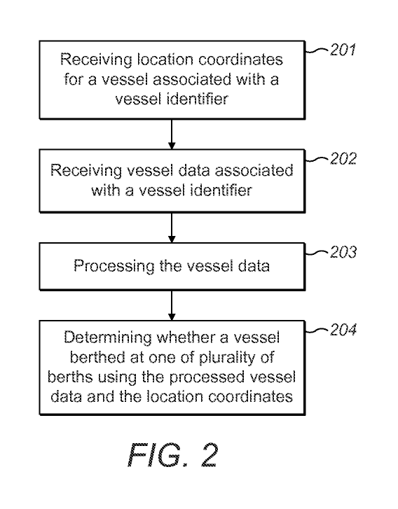

In FIG. 2, a method in accordance with an embodiment of the invention will be described.

In step 201, location coordinates are received for a vessel. The vessel may be associated with a vessel identifier. The location coordinates may be received from an aggregator system.

In step 202, vessel data associated with the vessel identifier is obtained. The vessel data may be obtained from a vessel statistics database. The vessel data may include the length of the vessel. The vessel data may include the vessel type.

In step 203, the vessel data is processed. The vessel data may be processed by a processing system. Where the vessel data includes the vessel length, the vessel length may be processed depending on the vessel type, whether the original obtained vessel length is within a range, and/or the type of berth at a berth location.

In step 204, whether the vessel is berthed at one of a plurality of berth locations is determined using the processed vessel data and the location coordinates. Step 204 may include determining whether the berth location is within a circle centred on the location coordinates with a radius of the processed vessel length.

The berth locations may be extracted from a berth database. The berth locations may be associated with a berth type (for example, whether the berth is of a fixed type or of a floating type).

In one embodiment, the velocity of the vessel is also received and used when determining whether the vessel is berthed. For example, only if the velocity of the vessel is below a threshold is the vessel considered berthed.

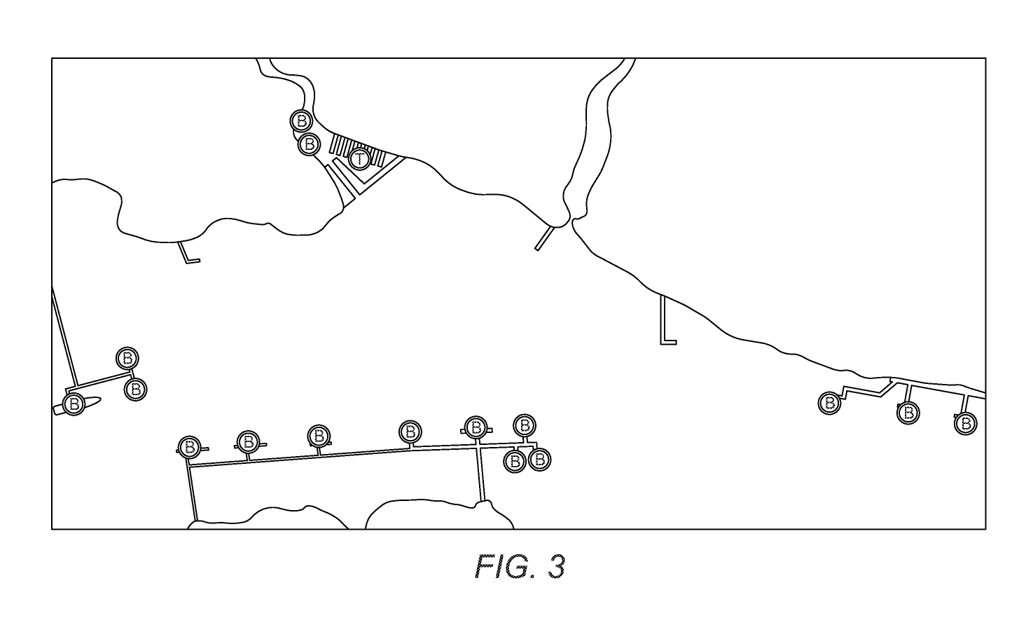

With reference to FIGS. 3 to 6, one embodiment of the invention will be described.

This embodiment comprises a berth database comprising berth location information.

The berth locations database contains approximately 20,000 berth locations in ports around the world.

FIG. 3 shows an example of mapped berth locations at Milford Haven. The ‘B’ icons indicate geo-referenced berth locations.

In this embodiment, GPS locations of vessels are obtained by tracking their AIS transmissions.

The Automatic Identification System (AIS) is an automatic tracking system used on ships and by vessel traffic services (VTS) for identifying and locating vessels by electronically exchanging data with other nearby ships, AIS base stations, and satellites. When satellites are used to detect AIS signatures then the term Satellite-AIS (S-AIS) is used. AIS information supplements marine radar, which continues to be the primary method of collision avoidance for water transport.

Information provided by AIS equipment, such as unique identification, position, course, and speed, can be displayed on a screen or an ECDIS. AIS is intended to assist a vessel's watch standing officers and allow maritime authorities to track and monitor vessel movements. AIS integrates a standardized VHF transceiver with a positioning system such as a LORAN-C or GPS receiver, with other electronic navigation sensors, such as a gyrocompass or rate of turn indicator. Vessels fitted with AIS transceivers and transponders can be tracked by AIS base stations located along coast lines or, when out of range of terrestrial networks, through a growing number of satellites that are fitted with special AIS receivers which are capable of de-conflicting a large number of signatures.

The International Maritime Organization's International Convention for the Safety of Life at Sea requires AIS to be fitted aboard international voyaging ships with gross tonnage (GT) of 300 or more tons, and all passenger ships regardless of size.

The AIS transmissions from vessels are collected via a combination of land based antennas and satellites. These positional data are then consolidated into single de-conflicting positions at the datacenter for each vessel and that is then used as the time-stamped location of the vessel together with other data collected such as the vessel's current speed, heading draught, destination and estimated arrival date/time.

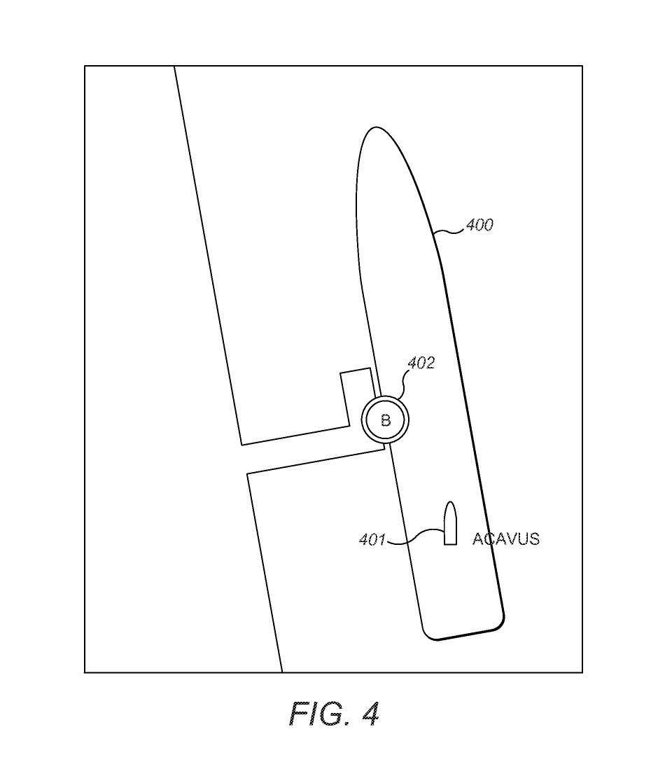

The AIS system provides a GPS location for the vessel from the position of the AIS transmitter. The AIS transmitter is most often on the bridge (at the back) of the vessel 400, as shown in FIG. 4 where 401 indicates the transmitter and 402 indicates the stored berth location. For this reason, it may be useful to utilize the length of vessel when determining whether the vessel is moored at a berth.

This embodiment utilizes information from a vessel statistics database system called IHS Fairplay to obtain the vessel length. IHS Fairplay holds critical information on over 180,000 ships over 100 gross tons. IHS Fairplay is also the originating source for assigning IMO Ship and Company numbers.

International Maritime Organization (IMO) numbers are unique identifiers for ships and for registered ship owners and management companies. They were introduced under the SOLAS Convention to improve maritime safety and security and to reduce maritime fraud.

This embodiment comprises a pre-processing system to process the AIS transmissions and a processing system to match vessel positions to berth locations.

The pre-processing system for processing AIS transmissions receives AIS data from over 180,000 vessels via many terrestrial antennas and satellites. This data is de-duplicated and consolidated into single de-conflicting positions.

The processing system processes the data feed of consolidated AIS vessel positions together with the database of vessel statistics and the berth locations database to produce berth callings.

### Processing to Determine Berth Callings

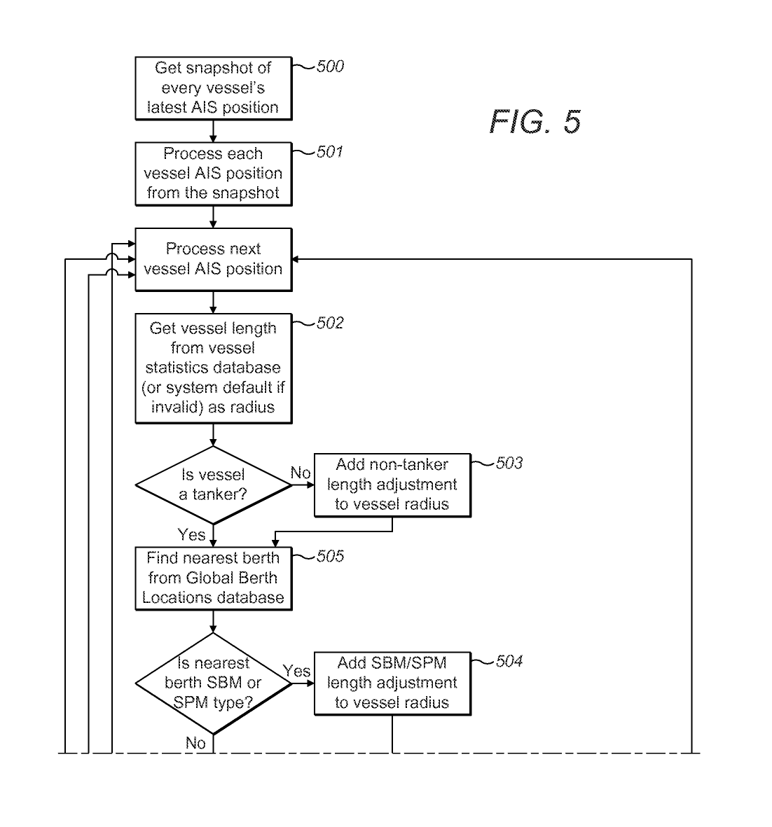

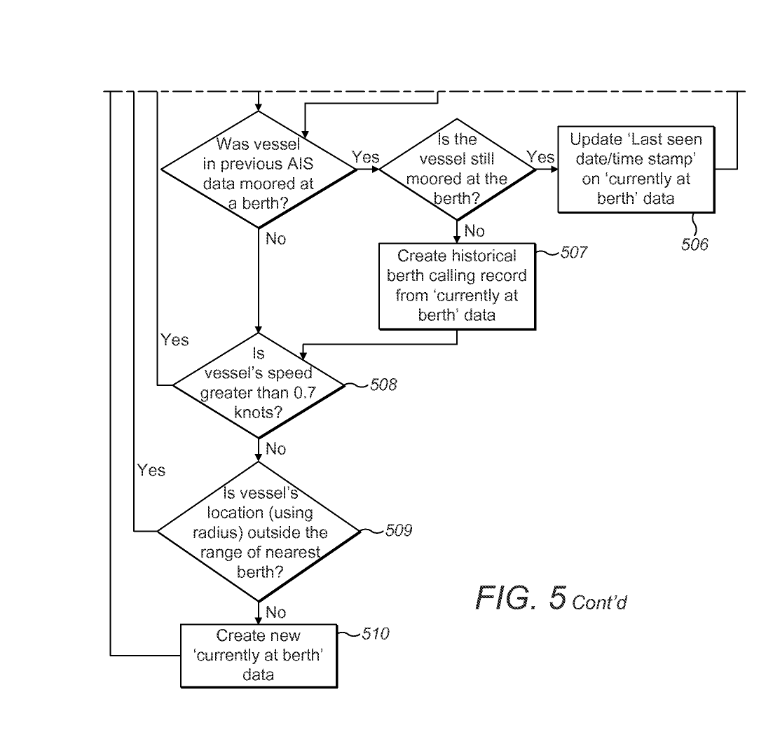

Utilizing the consolidated AIS data feed, vessel statistics database and the global berth locations database the following method, shown in FIG. 5, is used to create berth callings:
1) In step 500, a snapshot of every vessel position is taken from the consolidated AIS data feed every 15 minutes. This contains the last received AIS position and other AIS data from over 180,000 vessels.
2) In step 501, each vessel AIS data record is then processed in turn to determine whether or not the vessel is currently at a berth following the following rules
   a. The vessel's length (from the Vessel Statistics Database) is used as a radius from each berths location (from the Global Berths Locations Database) to determine if the vessel is close enough to be deemed as moored at that berth
      i. If the vessel length in the Vessel Statistics Database is invalid (either zero or greater than 500 meters) then a default (system configurable) vessel length is used in step 502.
   b. If the vessel is not a tanker (determined from the Vessel Statistics Database) then an additional length (configurable) is added to the vessels length for the radius distance from the berth in step 503. This is because tankers moor near to fixed position connectors to off load liquid cargos whereas bulk vessels are not so precise in their mooring locations.
   c. If the berth is a SBM or SPM type (determined from the Global Berths Locations Database) then an additional length (configurable) is added to the vessels length for the radius distance from the berth in step 504. This is because SBM and SPM type berths are at sea and thus have no fixed point. A Single buoy mooring (SBM) (also known as single-point mooring or SPM) is a loading buoy anchored offshore, that serves as a mooring point and interconnect for tankers loading or offloading gas or liquid products. SPMs are the link between geostatic subsea manifold connections and weathervaning tankers. They are capable of handling any size ship, even very large crude carriers (VLCC) where no alternative facility is available.
      In an alternative embodiment, GPS location information for the SBM or SPM types are regularly received and integrated into the Berths Locations Database to provide accurate location information for these movable berths. In this embodiment, the additional length to be added is not required.
   d. In step 505, if more than one berth is within range of the vessel then the closest berth is used.
   e. A database is maintained of all vessels determined to be currently moored at berths and is used to calculate the arrival and departure date/time of every berth calling.
   f. If the vessel was previously determined to be moored at a berth i.e. currently at a berth then:
      i. If the vessel's AIS location is still within the calculated radius of that berth location then the ‘last seen timestamp’ data is updated from the AIS data onto the ‘Vessel currently at berth’ data record of that berth calling and the record is finished processing in step 506
      ii. If the vessel's AIS location is now outside the ‘current berth’ then a historical berth calling is created for the previous ‘currently at berth’ data in step 507. This data includes the arrival timestamp and arrival current draught data from the AIS data and the ‘last seen timestamp’ as the departure date/timestamp together with the current draught as the departure draught. Note that the ‘current draught’ of the vessel outside the berth is used as the departure draught—this is because vessels often update this data in their AIS transmissions after they have left the berth.
   g. In step 508, if the vessel's current speed (from AIS data) is greater than 0.7 knots then the vessel is not deemed to be moored and the record is finished processing.
   h. However, in step 509, if the vessel's current speed (from AIS data) is not greater than 0.7 knots and the vessel is within range of the nearest berth then a new ‘Vessel currently at berth’ database record is created in step 510. This record contains the AIS last seen timestamp as the berth arrival date/time stamp and the current draught as the berth arrival draught.

To calculate the nearest berth to a vessel a k-d tree algorithm may be used. A k-d tree (short for k-dimensional tree) is a space-partitioning data structure for organizing points in a k-dimensional space. k-d trees are a useful data structure for several applications, such as searches involving a multidimensional search key (e.g. range searches and nearest neighbor searches). k-d trees are a special case of binary space partitioning trees.

K-d tree processing is a binary tree search that can be used for multiple dimensions. It will be appreciated that other processing methods could be used to calculate the nearest berth location.

Distance calculations from the vessel to the nearest berth may be performed using the Haversine formula which uses a spherical approximation of the Earth. Values are known to differ from reality by as much as 0.3% and this is sufficiently accurate for the distance calculation.

It will be appreciated that other processing methods could be used to calculate the vessel to berth distances.

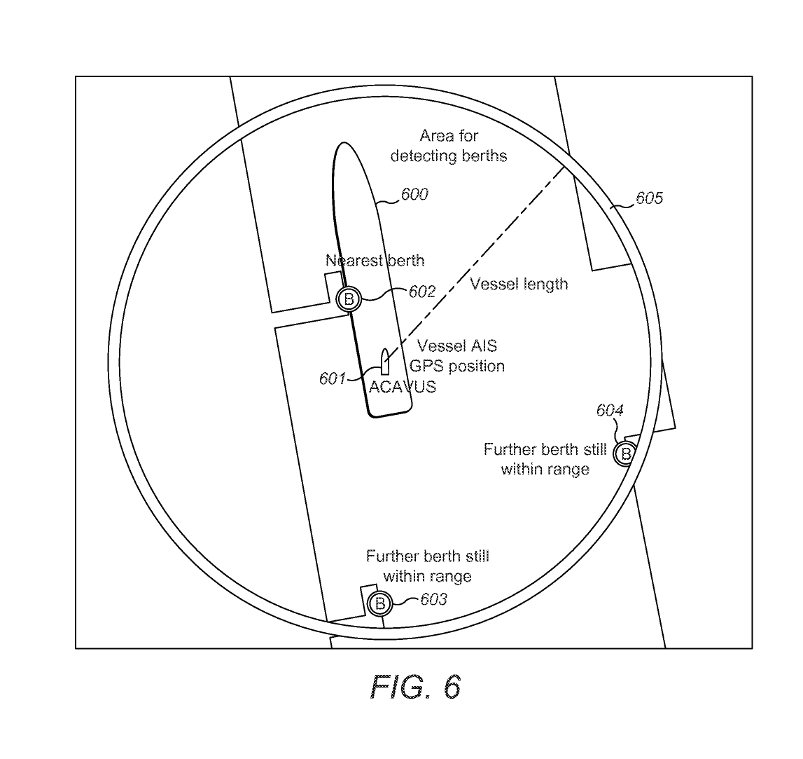

FIG. 6 illustrates in greater detail an example of how a vessel is detected at berth in accordance with an embodiment of the invention.

A vessel 600 is shown. The vessel 600 includes a location detection device 601. The location detection device provides location coordinates at the device's location aft of the vessel 600. Berth locations 602, 603, and 604 within a circle 605 centred on the location coordinates of a radius of the length of the vessel 600 are detected. In this case, multiple berth locations 602, 603, and 604 are detected. The berth 602 closest to the location coordinates is selected as the berth at which the vessel is moored.

### Database Records

The database records created and maintained for berth callings during one or more of the embodiments currently are:

### Vessels Currently at Berths

Berth identifier: unique key identifier of the berth in the Global Berth Locations Database
Vessel ID: the IMO or MMSI (see below) of the vessel is used from the Vessel Statistics database. Note that both the IMO and MMSI numbers are included within the AIS data transmitted by the vessels
Arrival date/time stamp: the first date/time stamp (from AIS data) of the vessel during its time moored at this berth calling
Arrival draught: the first value of the current draught (from AIS data) of the vessel during its time moored at this berth calling
Last seen date/time stamp: the most recent date/time stamp from AIS of the vessel during its time moored at this berth calling

### Historical Berth Callings

Berth identifier: unique key identifier of the berth in the Global Berth Locations Database
Vessel ID: the IMO or MMSI (see below) of the vessel is used from the Vessel Statistics database. Note that both the IMO and MMSI numbers are included within the AIS data transmitted by the vessels
Arrival date/time stamp: the first date/time stamp (from AIS data) of the vessel during its time moored at this berth calling
Arrival draught: the first value of the current draught (from AIS data) of the vessel during its time moored at this berth calling
Departure date/time stamp: the last date/time stamp (from AIS data) whilst the vessel was moored at the berth. Note this is the ‘last seen date/time stamp’ from the ‘vessels currently at berths’ when the vessel left the berth
Departure draught: this is the ‘current draught’ value (from AIS data) from the first AIS record after the vessel left the berth

The Maritime Mobile Service Identity (MMSI) is a series of nine digits which are sent in digital form over a radio frequency channel in order to uniquely identify ship stations, ship earth stations, coast stations, coast earth stations, and group calls. These identities are formed in such a way that the identity or part thereof can be used by telephone and telex subscribers connected to the general telecommunications network to call ships automatically.

In one embodiment, the berths may include Floating storage vessels. A floating production, storage and offloading (FPSO) unit is a floating vessel used by the offshore oil and gas industry for the processing of hydrocarbons and for storage of oil. An FPSO vessel is designed to receive hydrocarbons produced from nearby platforms or subsea template, process them, and store oil until it can be offloaded onto a tanker or, less frequently, transported through a pipeline. FPSOs are preferred in frontier offshore regions as they are easy to install, and do not require a local pipeline infrastructure to export oil. FPSOs can be a conversion of an oil tanker or can be a vessel built specially for the application. A vessel used only to store oil (without processing it) is referred to as a floating storage and offloading vessel (FSO). There are also under construction (as at 2013) Floating Liquefied Natural Gas (FLNG) vessels, which will extract and liquefy natural gas on board.

A potential advantage of some embodiments of the present invention is that timely and accurate berth callings for vessels may be determined.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A method of tracking a vessel at a processing system, including:
a) receiving location coordinates for the vessel associated with a vessel identifier;
b) obtaining vessel data associated with the vessel identifier;
c) processing the vessel data; and
d) determining whether the vessel is berthed at one of a plurality of berth locations using the processed vessel data and the location coordinates.

2. A method as claimed in claim 1, wherein the vessel data includes the length of the vessel.

3. A method as claimed in claim 2, wherein processing the vessel data includes specifying a predefined length for the length of the vessel when the length of the vessel is outside a predefined range.

4. A method as claimed in claim 2, wherein processing the vessel data includes increasing the vessel length by a predefined length when the vessel is not a tanker.

5. A method as claimed in claim 1, wherein the location coordinates are received from the vessel.

6. A method as claimed in claim 1, the vessel identifier is received from the vessel.

7. A method as claimed in claim 1, wherein the location coordinates are received via a vessel location aggregator.

8. A method as claimed in claim 1, further including the step of receiving vessel information from the vessel.

9. A method as claimed in claim 8, wherein the vessel information includes vessel velocity.

10. A method as claimed in claim 1, wherein the step of determining whether the vessel is berthed includes the use of vessel velocity.

11. A method as claimed in claim 10, wherein the vessel is determined to be berthed, at least, if the velocity of the vessel is below a threshold.

12. A method as claimed in claim 2, wherein the vessel is determined to be berthed at a berth location, at least, if the berth location is within a circle centred at the location coordinates with a radius of the processed vessel length.

13. A method as claimed in claim 1, wherein the vessel is determined to be berthed at a berth location, at least, if the berth location is the closest berth location to the location coordinates.

14. A method as claimed in claim 1, wherein the plurality of berth locations include berth information.

15. A method as claimed in claim 1, wherein the berth information includes whether the berth is fixed or floating.

16. A method as claimed in claim 2, wherein the berth information includes whether the berth is fixed or floating and wherein, if the berth is floating, the processed vessel length is increased by a predefined length.

17. A system for tracking vessels, including:
a processing system configured for receiving location coordinates for the vessel associated with a vessel identifier; obtaining vessel data associated with the vessel identifier; processing the vessel data; and determining whether the vessel is berthed at one of a plurality of berth locations using the processed vessel data and the location coordinates; and
a berth database configured for storing berth locations.
